(19) United States
(12) Patent Application Publication
(10) Pub. No.: US 2015/0007807 A1
(43) Pub. Date: Jan. 8, 2015

(54) GRILLS

(71) Applicant: MINH N. NGUYEN, Atlanta, GA (US)

(72) Inventor: MINH N. NGUYEN, Atlanta, GA (US)

(21) Appl. No.: 14/325,324

(22) Filed: Jul. 7, 2014

Related U.S. Application Data
(60) Provisional application No. 61/843,156, filed on Jul. 5, 2013.

(51) Int. Cl. A47J 37/07; F24C 15/00

(52) U.S. Cl. CPC A47J 37/0786; F24C 15/001
USPC 126/25 R; 126/287

(57) ABSTRACT

A representative grill includes a grill base, a grill lid, and a grill flue device. The grill lid is in hinged communication with the grill base. The grill flue device includes a front panel and side panels and is pivotally attached to the grill base and the grill lid. In an opened position, the grill lid forms a rear wall and the grill flue device forms a front wall that directs smoke from the grill base through the opening between the grill lid and the grill flue device.

### CROSS-REFERENCE TO RELATED APPLICATIONS

This application claims benefit to U.S. provisional application entitled, “Improvements to Grills,” having Ser. No. 61/843,156, filed on Jul. 5, 2013, and is related to U.S. nonprovisional patent application entitled, “Grill and Method of Use,” having Ser. No. 14/081,608, filed on Nov. 15, 2013, which claims the benefit of U.S. provisional application entitled, “Improvements to Grills,” having Ser. No. 61/771,147, filed on Mar. 1, 2013, the benefit of U.S. provisional application entitled, “Improvements to Grills,” having Ser. No. 61/823,260, filed on May 14, 2013, the benefit of U.S. provisional application entitled, “Improvements to Grills,” having Ser. No. 61/823,490, filed on May 15, 2013, the benefit of U.S. provisional application entitled, “Improvements to Grills,” having Ser. No. 61/841,727, filed on Jul. 1, 2013, and is related to U.S. nonprovisional application entitled, “Grill and Method of Use Thereof,” having Ser. No. 13/712,972, filed on Dec. 13, 2012, which is a continuation of U.S. utility application entitled, “Grill and Method of Use Thereof,” having Ser. No. 12/893,130, filed on Sep. 29, 2010, which is a continuation-in-part of U.S. utility application entitled, “Grill and Method of Use Thereof,” having Ser. No. 12/574,028, filed on Oct. 6, 2009, all of which are entirely incorporated herein by reference.

### TECHNICAL FIELD

The present disclosure is generally related to grills and methods of use thereof and, more particularly, is related to grills having a flue that facilitates directing smoke away from the front of the grill.

### BACKGROUND

Barbeque pits are desirable for many occasions that require food to be cooked outdoors, such as family reunions, picnics, barbeques and company functions. Most available grills contain a door, which is opened to remove or add food to the grill, or to check on the cooking progress of the food. In order to open the door, however, the user has to stand relatively close to the front of the grill, and upon opening the door, the user is met with a blast of hot smoke. Such a situation is not only inconvenient, but also dangerous, as a user may inhale hot and intense smoke fumes.

Several previous devices have attempted to overcome the aforementioned problem with varying levels of success. One such device teaches a grill with a conventional grill cover that has an opening with a transparent vent window covering the opening. In use, the vent window selectively rotates about its front hinge, thereby causing the rear portion of the vent window to rise at a desirable angle away from the grill cover, and therefore exposing the opening. While such a device creates an opening through which smoke escapes, it lacks the ability to create a flue effect to direct smoke away from the user towards the rear of the grill when the grill cover is in an open position.

Another device teaches a typical grill lid having an opening and a glass panel. The glass panel is slidable along lined tracks. The glass panel may be slid inwardly to cover the opening or outwardly to expose the opening. While such a device covers the opening of a grill, the glass panel is not taught to be removable during the cooking process, and is only taught to be removable for cleaning purposes. Further, such a device lacks the ability to create a flue that moves smoke to the rear of the grill as the smoke exits.

Desirable in the art is an improved grill lid that would improve upon the conventional grill lid.

### SUMMARY

An improved grill is disclosed. A representative grill includes a grill base, a grill lid, and a grill flue device. The grill lid is in hinged communication with the grill base. The grill flue device includes a front panel and side panels and is pivotally attached to the grill base and the grill lid. In an opened position, the grill lid forms a rear wall and the grill flue device forms a front wall that directs smoke from the grill base through the opening between the grill lid and the grill flue device.

Other apparatuses, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a side view of a grill that illustrates an embodiment of the present invention from the side views;

FIG. 2 is a side view of a grill lid that illustrates the grill lid in a partially closed/opened position;

FIG. 3 is a side view of a grill lid that illustrates the grill lid in a closed position;

FIG. 4 is a front view of a grill lid that illustrates an opened grill lid and an erected flue;

FIG. 5 is a front view of a grill lid that illustrates a closed grill lid and a concealed grill flue device;

FIG. 6 is a front view of a grill lid that illustrates an opened grill lid and an erected flue in accordance with another embodiment of the present invention;

FIG. 7 is a front view of a grill lid, such as that shown in FIG. 6, that illustrates a closed grill lid and a concealed flue;

FIG. 8 is a side view of a grill that illustrates another embodiment of the present invention; and

FIG. 9 is a side view of a grill, such as that shown in FIG. 8, that illustrates an opened position.

### DETAILED DESCRIPTION

Exemplary systems are first discussed with reference to the figures. Although these systems are described in detail, they are provided for purposes of illustration only and various modifications are feasible.

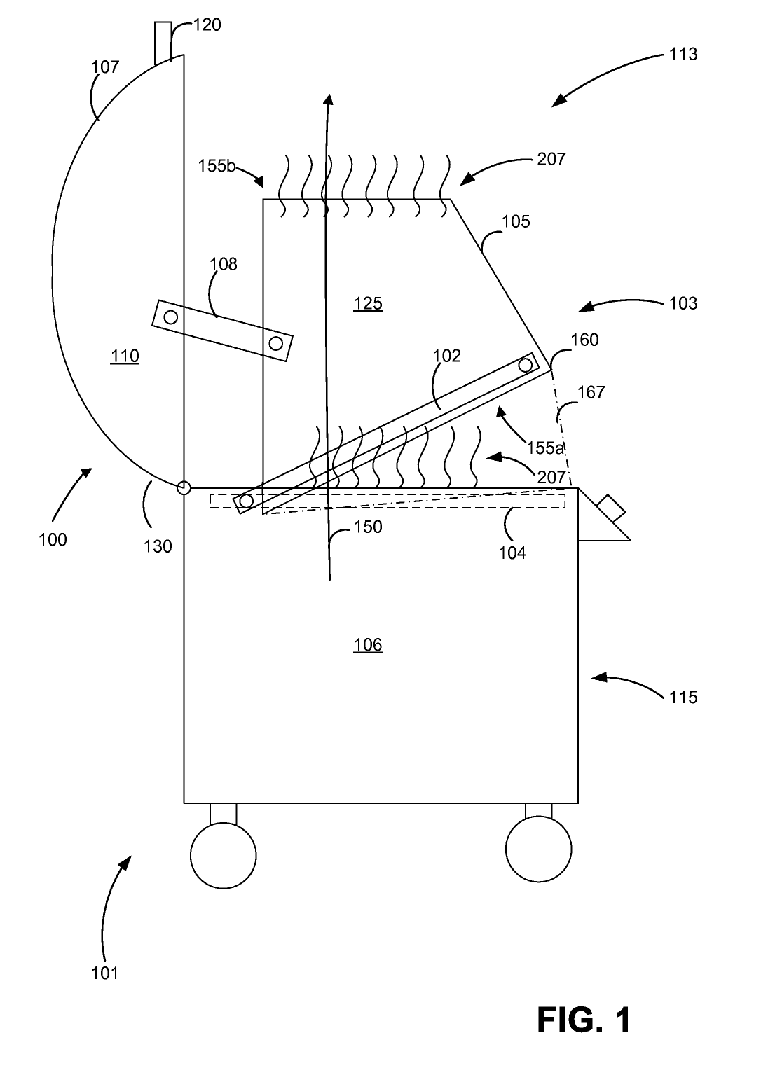

FIG. 1 is a side view of a grill 101 that illustrates an embodiment of the present invention. The grill lid 100 is in hinged communication and placed on top of a grill base 115, and is attached with a handle 120 that is disposed at a front wall 107 of the grill lid 100. The grill lid 100 further includes side walls 110 and a rear wall 130. In this example, from a side view, the shape of the grill lid 100 is substantially oval but a person skilled in the art can appreciate that the shape of the grill lid 100 can be any shapes.

A grill flue device 103 is pulled into an erected position when the grill lid 100 is in the opened position, such as that shown in FIG. 1. The grill lid 100 forms a rear wall and the grill flue device 103 forms a front wall that directs smoke 207 from the grill base through the opening 155 between the grill lid 100 and the grill flue device 103. In this example, the grill flue device 103 includes a front panel 105 that is attached at the left and right edges of the front panel 105 to left and right side walls 106 of the grill base 115.

The front panel 105 of the grill flue device 103 can include side panels 125 that are attached substantially perpendicular to the planar surface of the front panel 105. The side panels 125 can horizontally extend from the front panel 105 to the grill lid 100 to form a four-sided flue 113. In this example, the grill lid 100, side panels 125, and front panel 105 directs and channels the heat and smoke 207 from a heat source (e.g. gas burner or charcoal) of a grill grate towards and out of the top opening 155 of the erected flue 113.

Alternatively or additionally, the sides 167 of the erected flue 113 can be extended to the side walls 106 of the grill base 115 to prevent any cross wind from entering the flue 113 and effecting the upward direction of the heat and smoke 207. The upward air velocity 150 of the heat and smoke 207 can be increase by designing the area of the top opening 155b of the erected flue 113 to be smaller than the area of the bottom opening 155a of the flue 113.

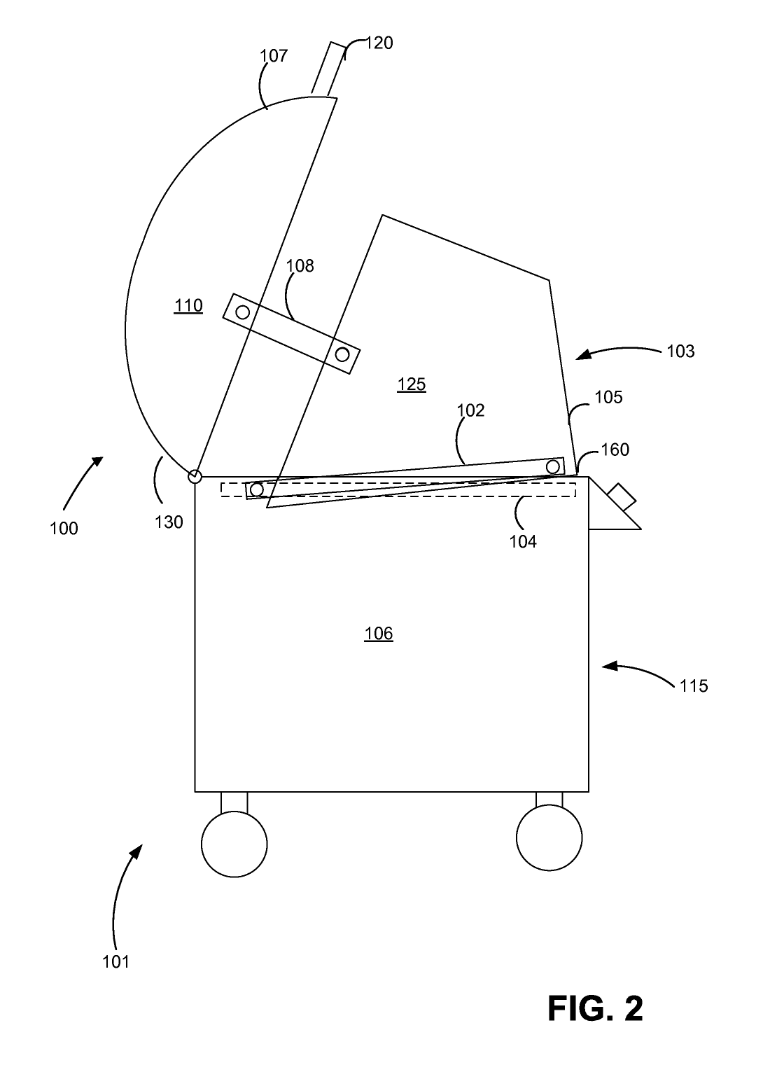

The side panels 125 are pivotally attached to proximal ends of two rear bars or cables 108, which are also pivotally attached to the side walls 110 of the grill lid 100 at the distal ends of the two rear bars or cables 108. The bottom, side edges of the front panel 105 are pivotally attached to proximal ends of side bars 102. The distal ends of the two side bars 102 can be pivotally attached at the top and left corner of the side walls 106 of the grill base 115, such as that shown in FIG. 1. The grill flue device 103 is further described in connection to FIGS. 2-4.

FIG. 2 is a side view of a grill lid 100 that illustrates the grill lid 100 in a partially closed/opened position. As the grill lid 100 is lowered the side bars 102 and/or front edge 160 can rest on the grate 104 of the grill base 115 or the top edge of the side walls 106 of the grill base 115. The front panel 105 can also be attached with a spring-loaded mechanism at the pivot attachment at the proximal edge of the side bars 102. The spring-loaded mechanism has a constant force to push the front panel 105 and side panels 125 in an upright position.

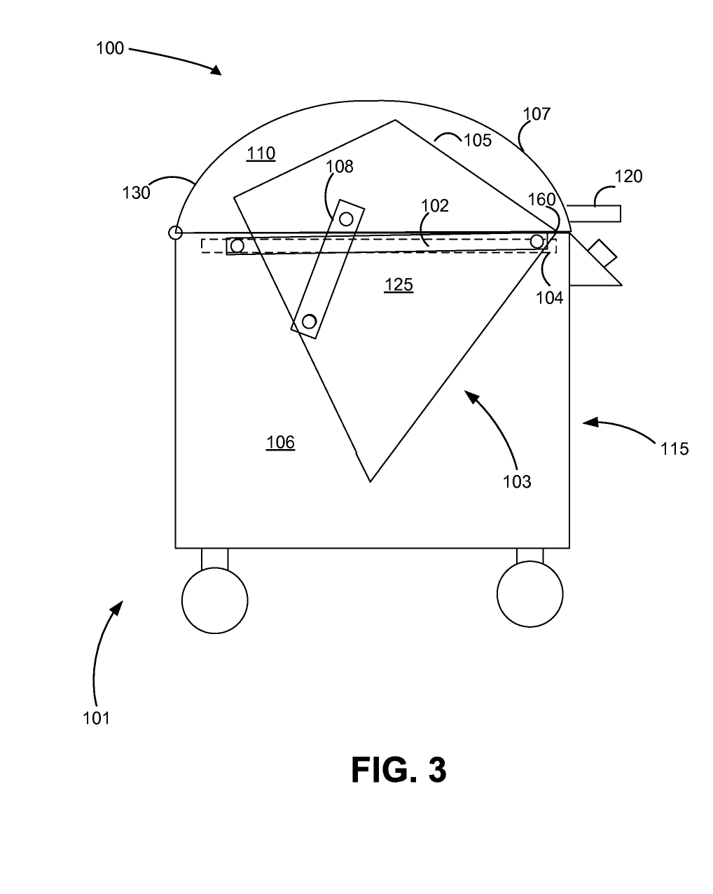

FIG. 3 is a side view of a grill lid 100 that illustrates the grill lid 100 in a closed position. As the grill lid 100 is lowered in the closed position, the front edge 160 rests on the top edge of the side wall 106 or the grate 104 and the front panel 105 and side panels 125 move downward via pivot attachment point at the proximal end of the side bars 102. As the grill lid 100 lowers the front panel 105 and side panels 125 downward, the side panels 125 can slide inside or outside the grill base 115.

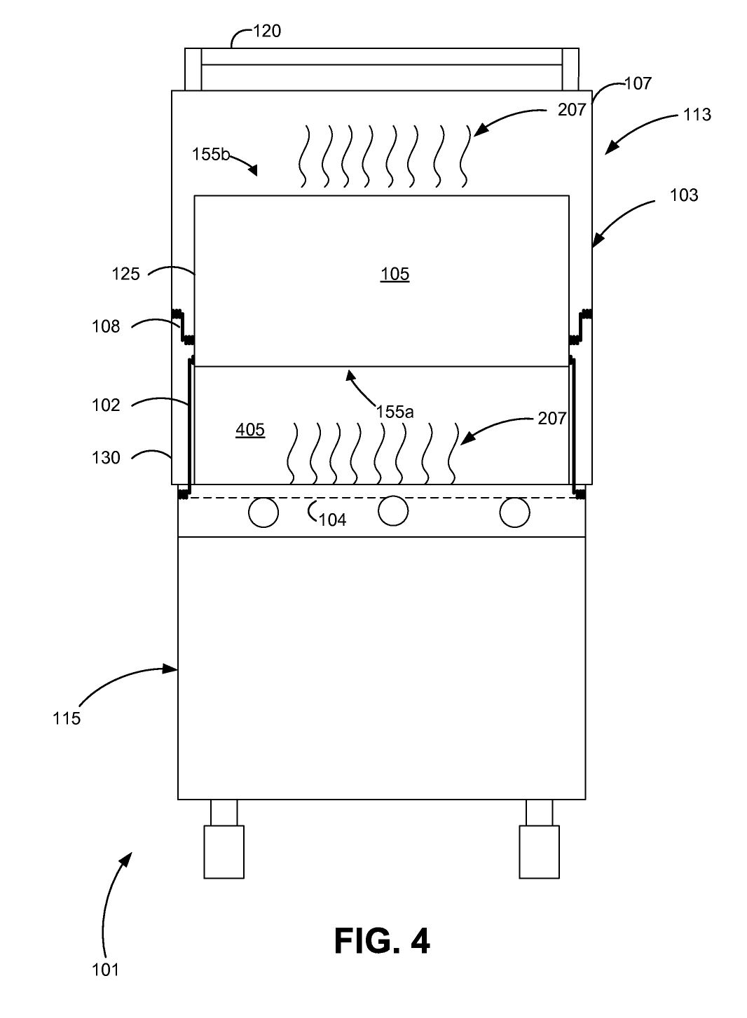

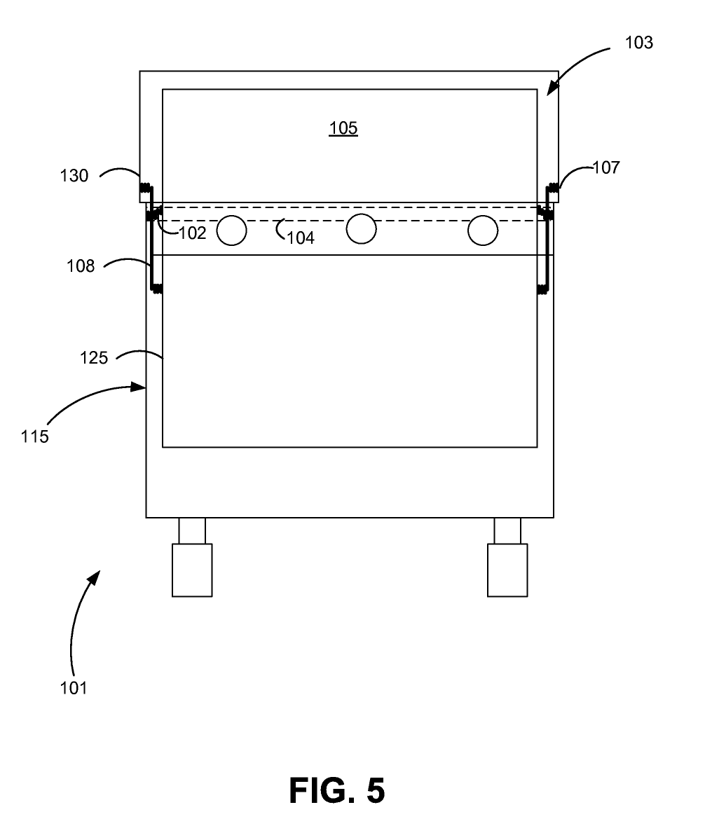

FIG. 4 is a front view of a grill lid 100 that illustrates an opened grill lid 100 and erected flue 113. In the example, the side panels 125 of the concealed grill flue device 103 can be disposed inside the grill base 115 in a closed position, such as that shown in FIG. 5. The front panel 105 shields the heat and smoke that can be generated from the grill base 115 as the grill flue device 103 is being erected. As the front panel 105 and the side panels 125 are erected upwardly by way of rear bars and/or cables 108 that are attached to the opened grill lid 100, the flue 113 directs the heat and smoke from the bottom opening 155a to the top opening 155b of the flue 113.

The flue 103 is fully erected by way of the grill lid 100 being pushed into an opened position. More specifically, the side panels 125 and front panel 105 of the flue 103 are pulled upward in conjunction with the grill lid 100 being pushed into the opened position by way of the rear bars and/or cable 108 being attached to the side panels 125 and grill lid 100. Alternatively or additionally, the erected flue 103 can be shaped substantially like a trapezoid with a rectangular base and sloping sides with respect to the front panel 105 and grill lid 100 that converge to a smaller top rectangular opening than the bottom rectangular base.

The convergence of the front panel 105 and the grill lid 100 can increase the air velocity caused by the heat within the grill lid 100. This increase in air velocity further assists in directing and channeling heat and smoke through the flue 113. The shape of the erected flue 113 can also be a float topped pyramid, a cylinder, a cone, cube, and other three dimensional shapes. It should be noted that the grill lid 100 can be designed such that the height of the grill lid 100 is taller than the height of the front panel 105. The grill lid 100 can prevent wind from flowing into the top opening of the flue 103 back into the grill opening 401 and toward the user. Alternatively or additionally, the side panels 125 can also be designed taller to cover the left and right sides of the erected flue 113. Alternatively or additionally, the rear bottom edge of the grill lid 100 can be attached to a spring which is also attached to a rear wall of the grill base 115. The spring assists the grill lid 100 to open as the user raise the grill up. The side bars 102 and rear bars 108 are pivotally attached with washers.

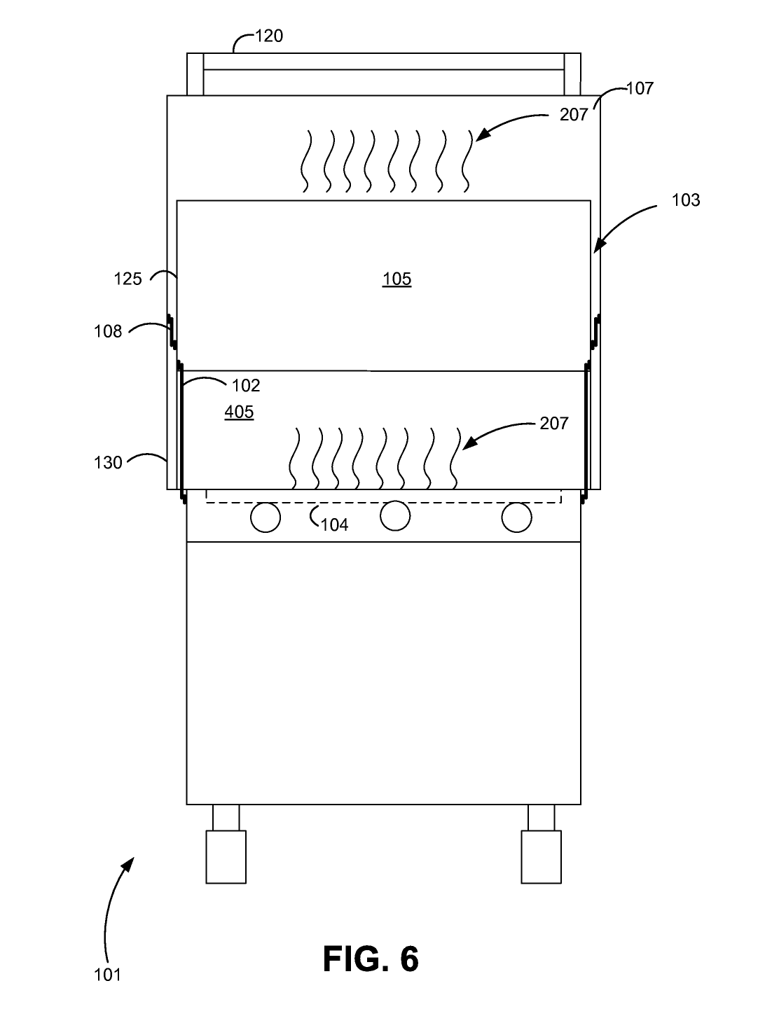

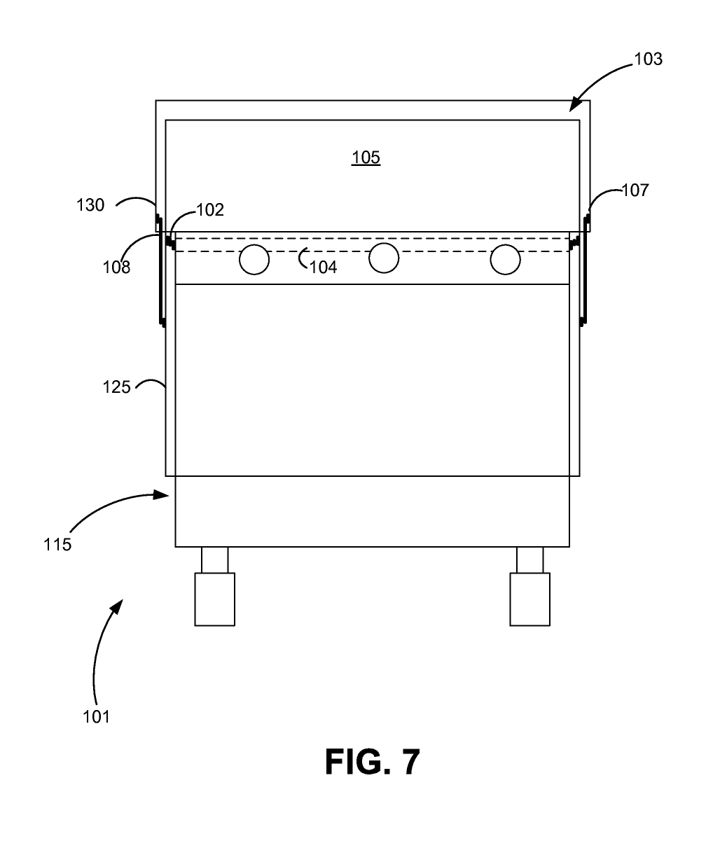

FIG. 6 is a front view of a grill lid that illustrates an opened grill lid and an erected flue in accordance with another embodiment of the present invention. In the example, the side panels 125 of the concealed grill flue device 103 can be disposed outside the grill base 115 in a closed position, such as that shown in FIG. 7.

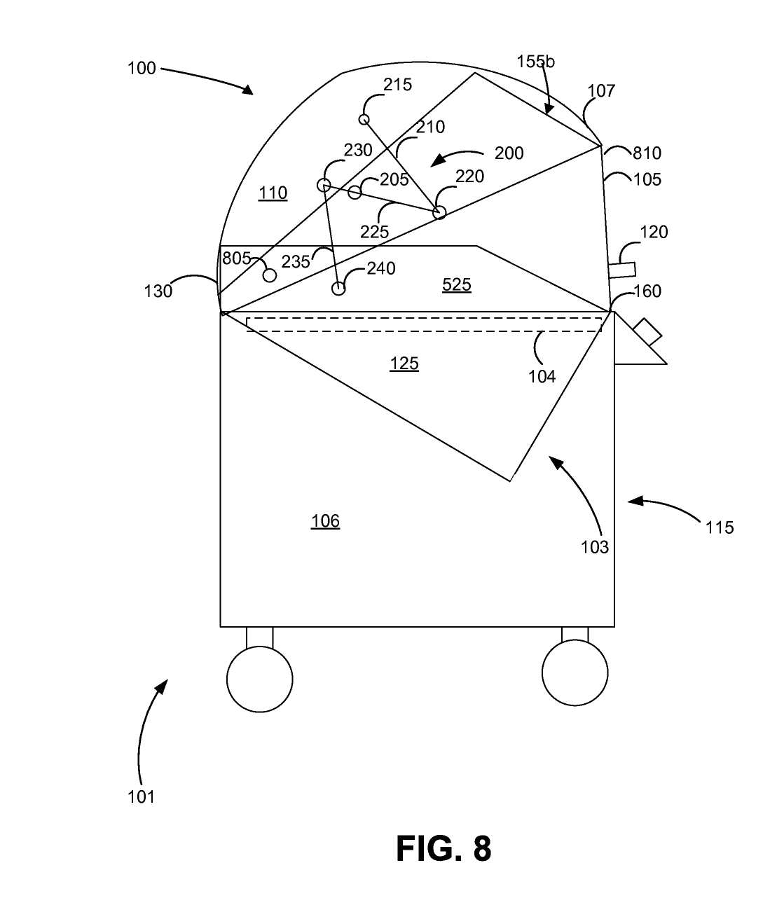

FIG. 8 is a side view of a grill 101 that illustrates another embodiment of the present invention. The grill lid 100 and grill flue device 103 are in hinged communication at hinge point 805 and placed on top of a grill base 115, more specifically to a top side wall of the grill base 115. The handle 120 is attached to the front panel 105 of the grill flue device 103. The front edge 160 of the front panel 105 of the grill flue device 103 rest on the top edge of the grill base 115. The front wall 107 of the grill lid 100 rest on the top edge 810 of the front panel 105 of the grill flue device 103. The grill lid 100 partially covers the grill flue device 103, specifically covers the top opening 155b.

An opening system 200 includes a lever system that includes a lever structure 225 that is pivotally attached at an attachment point 205 to a sidewall 110 (FIG. 1) of the grill lid 100 and a rear bar 210 that is pivotally attached to a distal end of the lever structure 225 and the side wall 110 of the grill lid 110 at attachment points 220, 215. A base structure 235 is pivotally attached at distal and proximal ends to a proximal end of the lever structure 225 and the top side panel 525 of the base grill 115 at attachment points 230, 240. Alternatively or additionally, the rear bar 210 can be pivotally attached to the side panel 525, which is attached to the top side panel 525. In this example, the lever and base structures 225, 235 are elongated bars.

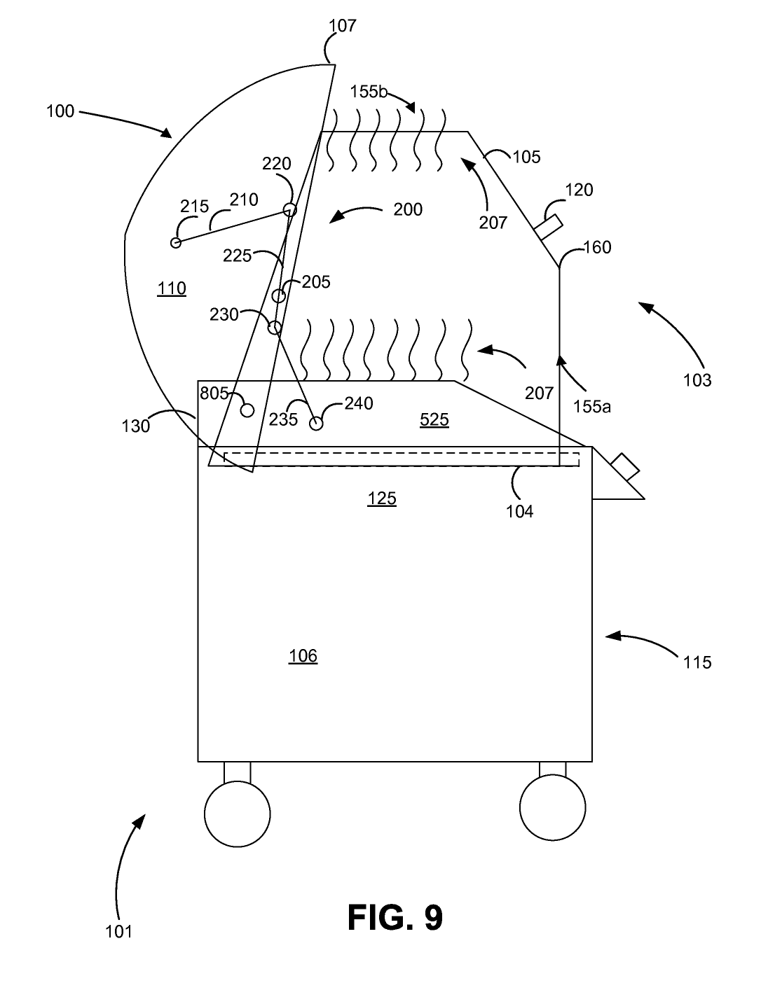

FIG. 9 is a side view of a grill 101, such as that shown in FIG. 8, that illustrates an opened position. The grill flue device 103 is pulled into an erected position as a user opens the grill lid 100. The grill lid 100 forms a rear wall and the grill flue device 103 forms a front wall that directs smoke 207 from the grill base 115 through the opening 155 between the grill lid 100 and the grill flue device 103. The opening system 200 assists opening the grill lid 100 with respect to the grill flue device 103, similar to that described in U.S. patent Ser. No. 14/081,608 entitled, “Grill and Method of Use,” filed on Nov. 15, 2013, all of which are entirely incorporated herein by reference.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

Therefore, having thus described the disclosure, at least the following is claimed:

1. A grill comprising:
a grill base;
a grill lid that is in hinged communication with the grill base; and
a grill flue device that includes a front panel and side panels,
wherein the grill flue device is pivotally attached to the grill base and the grill lid,
wherein in an opened position, the grill lid forms a rear wall and the grill flue device forms a front wall that directs smoke from the grill base through the opening between the grill lid and the grill flue device.

2. The grill as defined in claim 1, wherein the side panels horizontally extend from the front panel to the grill lid to form a four-sided flue.

3. The grill as defined in claim 2, wherein the side panels extend to the side wall of the grill base to prevent any cross wind from entering the flue.

4. The grill as defined in claim 1, further comprising rear bars or cables that are pivotally attached to the side panels at the proximal ends of rear bars or cables, which are also pivotally attached to the side walls of the grill lid at the distal ends of the rear bars or cables.

5. The grill as defined in claim 1, further comprising side bars that are pivotally attached to the bottom, side edges of the front panel at the proximal ends of side bars.

6. The grill as defined in claim 5, wherein the distal ends of the side bars are pivotally attached at the top and left corner of the side walls of the grill base.

7. The grill as defined in claim 1, further comprising a spring-loaded mechanism that is attached to the front panel at the pivot attachment at the proximal edge of the side bars.

8. A grill comprising:
a grill base;
a grill lid that is in hinged communication with the grill base; and
a grill flue device that included a front panel and side panels,
wherein the grill flue device is pivotally attached to the grill base and the grill lid,
wherein in an opened position, the grill lid forms a rear wall and the grill flue device forms a front wall that directs smoke from the grill base through the opening between the grill lid and the grill flue device,
wherein the side panels horizontally extend from the front panel to the grill lid to form a four-sided flue.

9. The grill as defined in claim 8, wherein the side panels extend to the side wall of the grill base to prevent any cross wind from entering the flue.

10. The grill as defined in claim 8, further comprising rear bars or cables that are pivotally attached to the side panels at the proximal ends of rear bars or cables, which are also pivotally attached to the side walls of the grill lid at the distal ends of the rear bars or cables.

11. The grill as defined in claim 8, further comprising side bars that are pivotally attached to the bottom, side edges of the front panel at the proximal ends of side bars.

12. The grill as defined in claim 11, wherein the distal ends of the side bars are pivotally attached at the top and left corner of the side walls of the grill base.

13. The grill as defined in claim 8, further comprising a spring-loaded mechanism that is attached to the front panel at the pivot attachment at the proximal edge of the side bars.

14. A grill flue device comprising:
a front panel;
side panels that are attached substantially perpendicular to the planar surface of the front panel;
rear bars or cables that are pivotally attached to the side panels at the proximal ends of rear bars or cables, wherein the rear bars or cables are designed to pivotally attach to side walls of a grill lid at the distal ends of the rear bars or cables; and
side bars that are pivotally attached to the bottom, side edges of the front panel at the proximal ends of side bars, wherein the distal ends of the side bars are pivotally attached at the top and left corner of side walls of a grill base.

15. The grill flue device as defined in claim 14, wherein the side panels are designed to horizontally extend from the front panel to the grill lid to form a four-sided flue.

16. The grill flue device as defined in claim 15, wherein the side panels extend to the side wall of the grill base to prevent any cross wind from entering the flue.

17. The grill flue device as defined in claim 14, further comprising a spring-loaded mechanism that is attached to the front panel at the pivot attachment at the proximal edge of the side bars.
